(19) United States
(12) Patent Application Publication
(10) Pub. No.: US 2020/0307849 A1
(43) Pub. Date: Oct. 1, 2020

(54) LABEL SYSTEM

(71) Applicant: TOSHIBA TEC KABUSHIKI KAISHA, Tokyo (JP)

(72) Inventor: Naoto KAKINOKI, Izunokuni Shizuoka (JP)

(21) Appl. No.: 16/799,059

(22) Filed: Feb. 24, 2020

(30) Foreign Application Priority Data
Mar. 26, 2019 (JP) 2019-058372

(51) Int. Cl. B65C 9/46; B65C 9/18; B41J 3/407

(52) U.S. Cl. CPC B65C 9/46; B41J 3/4075; B65C 9/18

(57) ABSTRACT

A label printing system includes a server including a storage device storing information about a number of remaining labels on each roll sheet, and a first controller updating the number of labels, and label printers each including a display, a printer printing on labels on an attached roll sheet, an input device accepting an input of a number of labels to be printed, and a second controller transmitting to the server the input number of labels to be printed. The first controller, upon receipt of the number of labels to be printed, selects one of roll sheets to be attached to the label printer based on the stored information, and returns its identification information. The second controller, upon receipt of the identification information, generates on the display a screen indicating the identification information.

### CROSS-REFERENCE TO RELATED APPLICATIONS

This application is based upon and claims the benefit of priority from Japanese Patent Application No. 2019-058372, filed on Mar. 26, 2019, the entire contents of which are incorporated herein by reference.

### FIELD

An embodiment of the present invention relates to a label system.

BACKGROUND

Conventionally, a label printer for printing information on a label has been known. In such a label printer, information is printed on a designated number of labels, which are attached on the surface of a roll sheet.

However, the conventional label printer cannot determine the number of labels on the roll sheet until the roll sheet is attached to the label printer.

### BRIEF DESCRIPTION OF THE DRAWINGS

FIG. 1 is a diagram illustrating a label system according to an embodiment.

FIG. 2 is a sectional side view of a label printer according to the embodiment.

FIG. 3 is a block diagram showing a hardware configuration of the label printer.

FIG. 4 is a diagram showing label information stored in a storage device of the label printer.

FIG. 5 is a block diagram showing a hardware configuration of a radio tag reader according to the embodiment.

FIG. 6 is a block diagram showing a hardware configuration of a server according to the embodiment.

FIG. 7 is a diagram showing a label table for storing the label information.

FIG. 8 is a diagram showing a functional configuration of a label system according to the embodiment.

FIG. 9 is a flowchart of the control process of the label printer.

FIG. 10 is a diagram showing information displayed on the label printer.

FIG. 11 is a diagram showing another information displayed on the label printer.

FIG. 12 is a flowchart of the control process of the radio tag reader.

FIG. 13 is a flowchart of the control process of the server.

### DETAILED DESCRIPTION

In general, according to one embodiment, a label printing system comprises a server including a storage device that stores information about a number of labels remaining on each of a plurality of roll sheets, and a first controller configured to update the number of labels, and one or more label printers each including a display device, a printing unit configured to print on labels on a roll sheet attached to the label printer, an input device configured to accept an input of a number of labels to be printed, and a second controller configured to transmit to the server the input number of labels to be printed. The first controller is further configured to, upon receipt of the number of labels to be printed from one of the label printers, select one of the roll sheets to be attached to the label printer based on the stored information, and return an identification information about the selected roll sheet, and the second controller is further configured to, upon receipt of the identification information from the server, generate on the display device a screen indicating the identification information.

A label system according to embodiments will now be described with reference to the accompanying drawings. It should be noted that the present invention is not limited to the embodiments described below.

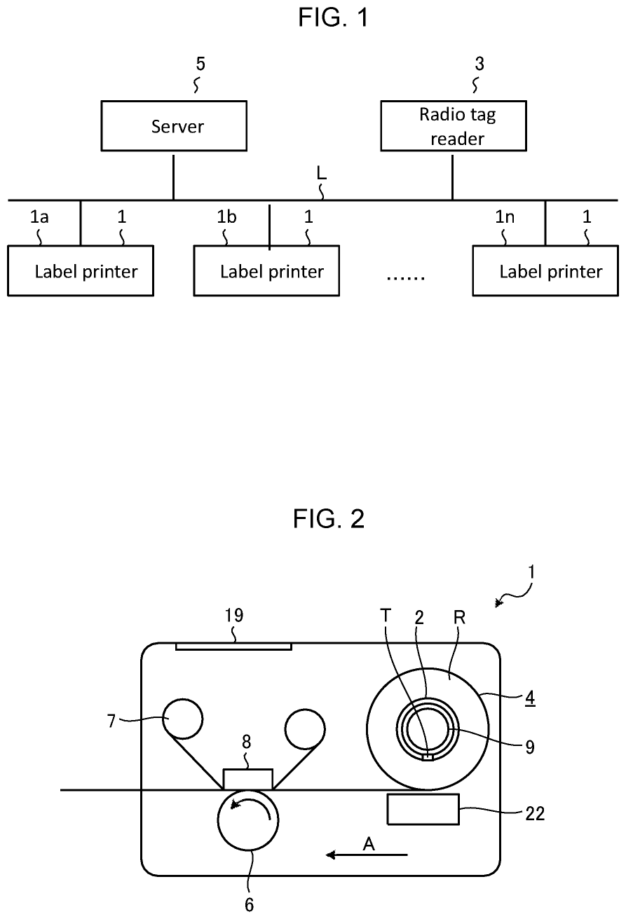

FIG. 1 is a diagram illustrating a label system according to an embodiment. As shown in FIG. 1, the label system includes a plurality of (for example, four) label printers 1 and one server 5. In addition, in FIG. 1 a radio tag reader 3 is provided in the label system. The label printers 1, the radio tag reader 3, and the server 5 are connected to each other by a network L such as a LAN (Local Area Network).

The label printer 1 transmits and receives information to and from another label printer 1, the radio tag reader 3, and the server 5 via the network L. The label printer 1 draws out, from a long base sheet of the roll sheet, unprinted labels, which are held at regular intervals on the long base sheet, and prints the information on the surface. The roll sheet has a paper pipe or a core on which a wireless tag that stores information about the labels is attached. The label printer 1 receives tag information from the radio tag. The label printer 1 will be described later with reference to FIG. 2.

The radio tag reader 3 transmits and receives information to and from the label printer 1 and the server 5 via the network L. The radio tag reader 3 includes an antenna 39 (see FIG. 5), and receives the tag information relating to the labels from the radio tag attached to the paper pipe of the roll sheet. The received tag information is transmitted to the server 5. That is, the radio tag reader 3 receives information about labels from the radio tag before the unused roll sheet is attached to the label printer 1.

The server 5 transmits and receives information to and from each of the label printer 1 and the radio tag reader 3 via the network L. The server 5 stores information about a type of labels of each roll sheet to be attached to the label printer 1.

Next, the structure of the label printer 1 will be described. FIG. 2 is a sectional side view of the label printer 1. As shown in FIG. 2, the label printer 1 includes a label holding unit 9, a platen 6, a thermal head 8, and the like. The label holding unit 9 holds the paper pipe 2 of a roll sheet 4 on which a label R is formed. The label holding unit 9 has a cylindrical shape, for example, and is inserted into the paper pipe 2 to hold the roll sheet 4. The platen 6 rotates in the direction indicated by the arrow, and draws the label R from the roll sheet 4 in the conveying direction A to convey the label R. The thermal head 8 is disposed at a position opposed to the platen 6, and applies heat to an ink ribbon 7 with respect to the drawn label R to print information. The radio tag T is embedded in, for example, the paper pipe 2, or is attached to the inner circle side of the paper pipe 2.

The label printer 1 comprises a radio tag R/W (reader/writer) 22. The Radio tag R/W 22 reads tag information relating to the labels of the roll sheet 4 transmitted from the radio tag T attached to the paper pipe of the roll sheet 4.

The label printer 1 comprises a display 19 on the upper surface thereof. The display 19 displays information for the operator of the label printer 1.

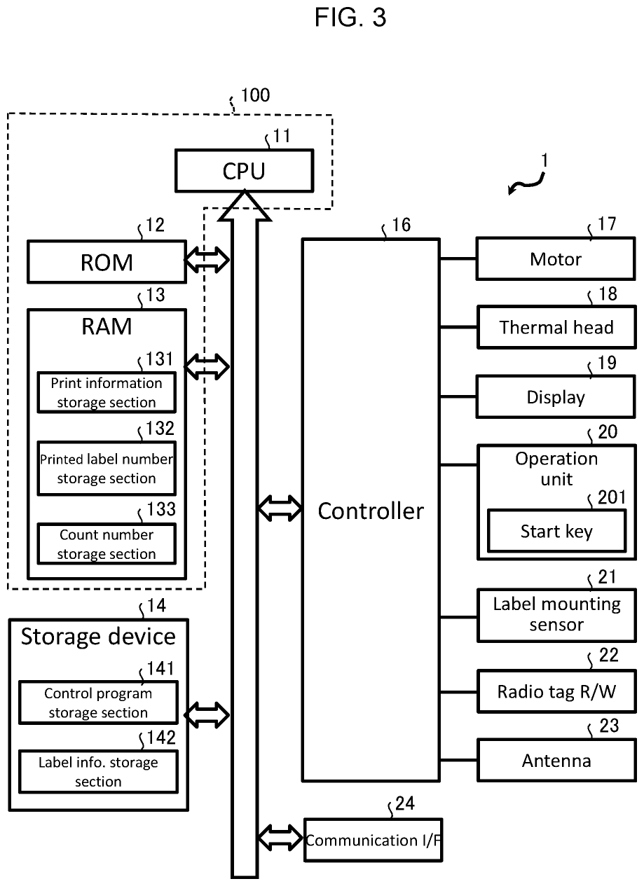

The hardware of the label printer 1 will now be described. FIG. 3 is a block diagram showing a hardware configuration of the label printer 1. As shown in FIG. 3, the label printer 1 includes a CPU (Central Processing Unit) 11, a ROM (Read Only Memory) 12, a RAM (Random Access Memory) 13, a storage device 14, and the like. The CPU 11 controls operations of the label printer 1. The ROM 12 stores various programs. The RAM 13 temporarily stores programs and various kinds of data. The storage device 14 stores various programs. The CPU 11, the ROM 12, the RAM 13, and the storage device 14 are connected to each other via a bus 15. The CPU 11, the ROM 12, and the RAM 13 make up a controller 100. That is, the controller 100 executes the control processing of the label printer 1, which will be described later, by the CPU 11 operating in accordance with the control program stored in the ROM 12 or the storage device 14 and loaded in the RAM 13.

The RAM 13 includes memory areas including a print information storage section 131, a label number storage section 132, and a count storage section 133. The print information storage section 131 stores print information including print data, e.g., characters or graphics to be printed on the label, and label type and label size received from the server 5 or other information processing apparatus (not shown). The label number storage section 132 stores the number of labels to be printed.

The storage device 14 is a hard disk drive (HDD), a flash memory, or the like, and maintains data even when the power supply is shut off. The storage device 14 includes storage areas including a control program storage section 141 and a label information storage section 142. The control program storage section 141 stores a control program for controlling the label printer 1. The label information storage section 142 stores label information of the labels of the roll sheet 4.

The controller 100 connects a motor 17, a thermal head 18, a display 19, an operation unit 20, the label mounting sensor 21, and a radio tag R/W 22 via the bus 15 and a controller 16. The motor 17 rotates the platen 6 in the direction indicated by the arrow. The thermal head 18 includes heating elements arranged in a line shape in a direction orthogonal to the conveying direction of the label R, and applies heat to the conveyed labels R to print information. The display 19 displays information for the operator who operates the label printer 1. The operation unit 20 is a keyboard including various keys including a start key 201. The start key 201 is operated by the operator when the label R is started to be printed by the label printer 1.

The label mounting sensor 21 detects that the roll sheet 4 is held by the label holding unit 9. The Radio tag R/W 22 includes an antenna 23, and reads through the antenna 23 label information relating to the labels of the roll sheet 4, emitted from the radio tag T attached to the paper pipe 2 of the roll sheet 4.

Further, the controller 100 is connected to the communication I/F 24 via the bus 15. The communication I/F 24 can transmit and receive information to and from another label printer 1, the radio tag reader 3, and the server 5 via the network L.

Next, a description will be given of the label information storage section 142. The label information storage section 142 stores label information of the labels of the roll sheet 4. When the roll sheet 4 attached to the label printer 1 is removed and another wound label 4 is newly mounted, the label information storage section 142 clears the number of sheets printed so far, and stores the label information of the labels of a newly mounted roll sheet 4.

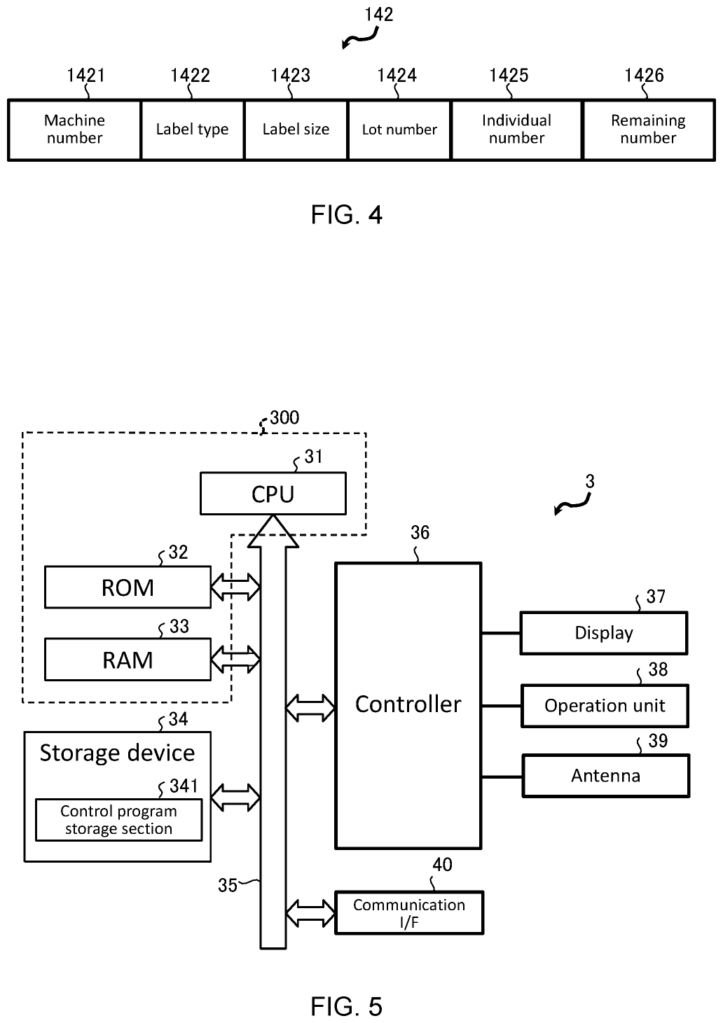

FIG. 4 is a diagram showing label information stored in the label information storage section 142.

As shown in FIG. 4, the label information storage section 142 stores a machine number 1421, a label type 1422, a label size 1423, a lot number 1424, an individual number 1425, and a remaining number 1426. The machine number 1421 is the machine number for specifying the label printer 1 to which the roll sheet 4 is attached. The label type 1422 is the type of label R of the roll sheet 4. The label type 1422 stores a label type, for example, a label suitable for long-term storage, a label suitable for short-term storage, or a label having a built-in radio tag. The label size 1423 is information indicating a size of the label R, e.g., a numerical value indicating the width and height of the label, a symbol indicating the size of the label, and the like. The lot number 1424 is a lot number of the roll sheet 4. The lot number is a management number given every fixed amount when the roll sheet 4 is manufactured. The same lot number may be assigned to a plurality of roll sheets 4 stored in the same corrugated board box. The manufacturing date and time of the roll sheet 4 may be identified by the lot number. The individual number 1425 is an individual number for individually specifying the roll sheet 4. One individual number specifies only one roll sheet 4. The remaining number 1426 is the remaining number of labels R held in the roll sheet 4. The remaining number of labels R is the number of labels on the label sheet 4 that can be printed.

The hardware configuration of the radio tag reader 3 will now be described. FIG. 5 is a block diagram showing a hardware configuration of the radio tag reader 3. As shown in FIG. 5, the radio tag reader 3 includes a CPU 31, a ROM 32, a RAM 33, a storage device 34, and the like. The CPU 31 controls the operations of the radio tag reader 3. The ROM 32 stores various programs. The RAM 33 temporarily stores programs and various kinds of data. The storage device 34 stores various programs. The CPU 31, the ROM 32, the RAM 33, and the memory 34 are connected to each other via a bus 35. The CPU 31, the ROM 32, and the RAM 33 make us a controller 300. That is, the controller 300 executes the control process of the radio tag reader 3 described later by the CPU 31 in accordance with the control program stored in the ROM 32 and the storage device 34 and loaded onto the RAM 33.

The RAM 33 comprises memory areas including a tag storage section 331. The tag storage section 331 stores tag information relating to the labels of the roll sheet 4 read from the radio tag T, which is attached to the paper pipe 2 of the unused roll sheet 4.

The storage device 34 is an HDD, a flash memory, or the like, and maintains data even when the power supply is shut off. The storage device 34 includes storage areas including a control program storage section 341. The control program storage section 341 stores a control program for controlling the radio tag reader 3.

The controller 36 connects a display 37, an operation unit 38, and an antenna 39 via the bus 35. The display 37 displays information for the operator of the radio tag reader 3. The operation unit 38 is a keyboard for the operator to operate the radio tag reader 3 to read the radio tag T. The antenna 39 receives tag information relating to the labels of the roll sheet 4 transmitted from the radio tag T. The radio tag reader 3 reads the tag information received by the antenna 39.

Further, the controller 300 is connected to a communication I/F 40 via the bus 35. The communication I/F 40 is capable of transmitting and receiving information to and from the server 5 via the network L.

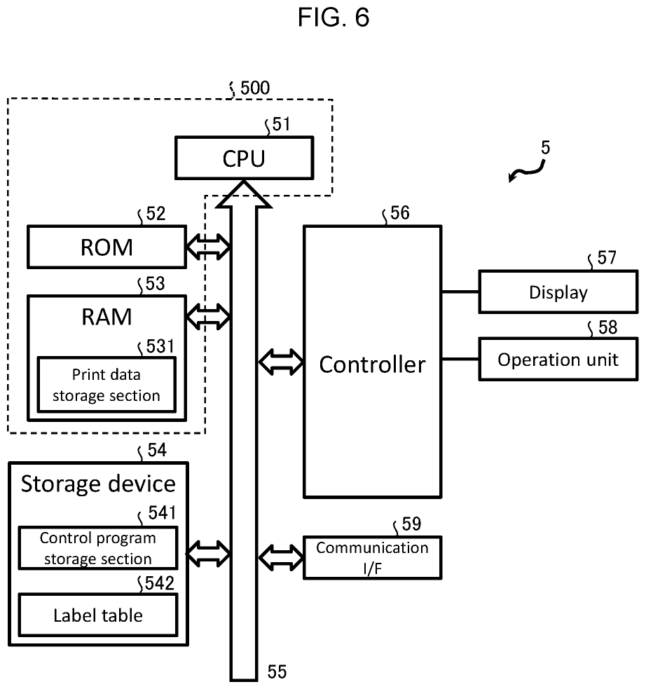

The hardware configuration of the server 5 will now be described. FIG. 6 is a block diagram showing a hardware configuration of the server 5. As shown in FIG. 6, the server 5 includes a CPU 51, a ROM 52, a RAM 53, a storage device 54, and the like. The CPU 51 controls the operations of the server 5. The ROM 52 stores various programs. The RAM 53 temporarily stores programs and various kinds of data. The storage device 54 stores various programs. The CPU 51, the ROM 52, the RAM 53, and the storage device 54 are connected to each other via a bus 55. The CPU 51, the ROM 52, and the RAM 53 make up a controller 500. That is, the controller 500 executes the control process of the server 5 described later by the CPU 51 in accordance with the control program stored in the ROM 52 and the storage device 54 and loaded onto the RAM 53.

The RAM 53 comprises memory areas including a print data storage section 531. The print data storage section 531 stores print data such as characters and figures to be printed on the labels of the roll sheet 4.

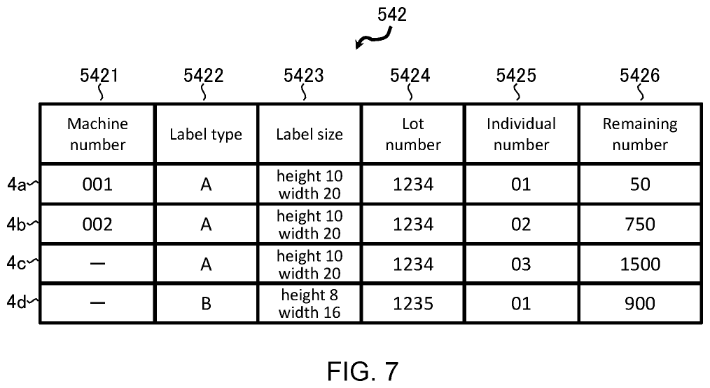

The storage device 54 is an HDD, a flash memory, or the like, and maintains data even when the power supply is shut off. The storage device 54 includes storage areas including a control program storage section 541 and a label table 542. The control program storage section 541 stores a control program for controlling the server 5. The label table 542 stores label information relating to one or more roll sheets 4. The label table 542 stores both label information of roll sheets 4 that are attached to one or more label printers 1 and label information of roll sheets 4 that are not attached to any label printer 1. The label table 542 stores label information related to an unused roll sheet 4 read by the radio tag reader 3. The label table 542 further stores the remaining number of labels R of each roll sheet 4. The remaining number of labels R is updated by subtracting the number of printed labels R from the current remaining number of labels R of the roll sheet 4. The label table 542 will be described later with reference to FIG. 7.

The controller 56 connects a display 57 and an operation unit 58 via the bus 55. The display 57 displays information for the operator of the server 5. The operation unit 58 is a keyboard for operating the server 5.

Further, the controller 500 is connected to a communication I/F 59 via the bus 55. The communication I/F 59 can transmit and receive information to and from each of the label printers 1 and the radio tag reader 3 via the network L.

Next, the label table 542 will be described. The label table 542 stores label information relating to all of the roll sheets 4 managed by the server 5. When label information relating to an unused roll sheet 4 is received from the radio tag reader 3, the label information is stored in the label table 542. When the unused roll sheet 4 is used in any one of the label printer 1, the remaining number of labels R related to the roll sheet 4 stored in the label table 542 is updated. The remaining number of labels R is calculated by subtracting the number of printed labels R from the current remaining number of label R of the unused label 4.

FIG. 7 is a diagram showing the label table 542 that stores the label information of the roll sheet 4. As shown in FIG. 7, the label table 542 includes a plurality of fields of a machine number 5421, a label type 5422, a label size 5423, a lot number 5424, an individual number 5425, and a remaining number 5426. The machine number field 5421 stores the machine number specifying the label printer 1 to which the roll sheet 4 is attached. When “-” is stored as the machine number 5421, the roll sheet 4 is not attached to any label printer 1. The label type field 5422 stores the type of label R of the roll sheet 4 attached to the label printer 1. The label size field 5423 stores the size of the label R. The lot number field 5424 stores the lot number in which the roll sheet 4 is manufactured. The individual number field 5425 stores individual numbers for individually specifying the roll sheet 4. One individual number specifies only one roll sheet 4. The remaining number field 5426 stores the remaining number of labels R of the roll sheet 4 specified by each individual number.

The label table 542 stores the machine number, label type, label size, lot number, individual number, and remaining number of labels for each roll sheet 4 read from the radio tag reader 3. In the example shown in FIG. 7, the label table 542 stores information of four roll sheets 4, i.e., the roll sheet 4a, the roll sheet 4b, the roll sheet 4c, and the roll sheet 4d.

For the roll sheet 4a, the machine number “001” is stored in the machine number field 5421. This indicates that the roll sheet 4a is attached to the label printer 1 having the machine number of “001”. In addition, “A” is stored in the label type field 5422 for the roll sheet 4a. This indicates that the label type of the label held by the roll sheet 4a is “A”. In addition, for the roll sheet 4a, the label size “height 10, width 20” is stored in the label size field 5423. This indicates that the label size held by the roll sheet 4a is “height 10 and width 20”. In addition, lot number “1234” is stored in the lot number field 5424 for the roll sheet 4a. This indicates that the lot number of the roll sheet 4a is “1234”. Further, the individual number “01” is stored in the individual number field 5425 for the roll sheet 4a. This indicates that the individual number of the roll sheet 4a is “01”. In addition, the remaining number “50” is stored in the remaining number field 5426 for the roll sheet 4a. This indicates that the number of remaining labels R in the roll sheet 4a is 50.

For the roll sheet 4b, the machine number “002” is stored in the machine number field 5421. This indicates that the roll sheet 4b is attached to the label printer 1 having the machine number of “002”. In addition, “A” is stored in the label type field 5422 for the roll sheet 4b. This indicates that the label type of the label held by the roll sheet 4b is “A”. In addition, for the roll sheet 4b, the label size “height 10, width 20” is stored in the label size storage field 5423. This indicates that the label size held by the roll sheet 4b is “height 10 and width 20”. Further, the lot number “1234” is stored in the lot number field 5424 for the roll sheet 4b. This indicates that the lot number of the roll sheet 4b is “1234”. In addition, the individual number “02” is stored in the individual number field 5425 for the roll sheet 4b. This indicates that the individual number of the roll sheet 4b is “02”. In addition, the remaining number “750” is stored in the remaining number field 5426 for the roll sheet 4b. This indicates that the number of remaining labels R in the roll sheet 4b is 750.

For the roll sheet 4c, the machine number “−” is stored in the machine number field 5421. This indicates that the roll sheet 4c is not attached to the label printer 1 and stored in a predetermined storage place. In addition, “A” is stored in the label type field 5422 for the roll sheet 4c. This indicates that the label type of the label held by the roll sheet 4c is “A”. In addition, for the roll sheet 4c, the label size “height 10, width 20” is stored in the label size field 5423. This indicates that the label size held by the roll sheet 4c is “height 10 and width 20”. Further, the lot number “1234” is stored in the lot number field 5424 for the roll sheet 4c. This indicates that the lot number of the roll sheet 4c is “1234”. Further, the individual number “03” is stored in the individual number field 5425 for the roll sheet 4c. This indicates that the individual number of the roll sheet 4c is “03”. In addition, the remaining number “1500” is stored in the remaining number field 5426 for the roll sheet 4c. This indicates that the number of remaining labels R in the roll sheet 4c is 50.

For the roll sheet 4d, the machine number “−” is stored in the machine number field 5421. This indicates that the roll sheet 4d is not attached to the label printer 1 and stored in a predetermined storage place. In addition, “B” is stored in the label type field 5422 for the roll sheet 4d. This indicates that the label type of the label held by the roll sheet 4d is “B”. In addition, for the roll sheet 4c, the label size “height 10, width 20” is stored in the label size field 5423. In addition, in the roll sheet 4d, the label size “height 8, width 16” is stored in the label size field 5423. This indicates that the label size held by the roll sheet 4d is “height 8 and width 16”. Further, the lot number “1235” is stored in the lot number field 5424 for the roll sheet 4d. This indicates that the lot number of the roll sheet 4d is “1235”. The individual number “01” is stored in the individual number field 5425 for the roll sheet 4d. This indicates that the individual number of the roll sheet 4d is “01”. In addition, the remaining number “900” is stored in the remaining number field 5426 for the roll sheet 4d. This indicates that the number of remaining labels R in the roll sheet 4d is 900.

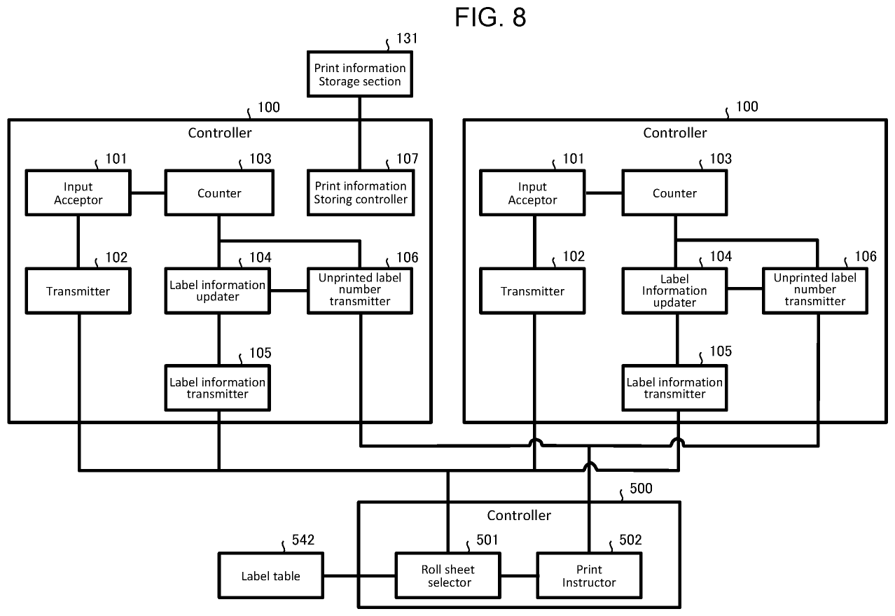

The functional configuration of the label system will now be described. FIG. 8 is a block diagram showing a functional configuration of the label system. As shown in FIG. 8, the label printer 1 in the label system performs functions of an input acceptor 101, a transmitter 102, a counter 103, a label information updater 104, a label information transmitter 105, and an unprinted label number transmitter 106 by executing a control program stored in the control program storage section 141 and loaded onto the RAM 13. The server 5 in the label system has functions of a roll sheet selector 501 and a print instructor 502 by executing a control program stored in the control program storage section 541 and loaded onto the RAM 53.

The input acceptor 101 accepts the input of the number of sheets of the label R to be printed. Specifically, the input acceptor 101 accepts the number of printed sheets of the label by storing the number of printed sheets of the label R input from the operation unit 20.

The transmitter 102 transmits the number of print sheets inputted via the input acceptor 101 to the server 5. Specifically, the transmitter 102 transmits the number of printed sheets and the machine number specifying the label printer 1 to the server 5.

The counter 103 counts and stores the number of labels printed by the label printer 1.

The label information updater 104 updates the remaining number of labels R 1426 based on the number of printed labels. Specifically, the label information updater 104 updates the remaining number of labels R 1426 by subtracting the number of printed labels stored in the count storage section 133 from the current remaining number 1426.

The label information transmitter 105 transmits the updated label information of the roll sheet 4 stored in the label information storage section 142 to the server 5.

When the label printer 1 runs out of the label R before printing the number of labels inputted by the input acceptor 101, the unprinted label number transmitter 106 transmits the number of unprinted labels to the server 5. Specifically, the unprinted label number transmitter 106 compares the number of printed labels R stored in the label number storage section 132 with the number of printed labels stored in the count storage section 133. When the number of printed sheets stored in the label number storage section 132 is larger than the number of printed labels stored in the count storage section 133, unprinted label number transmitter 106 transmits to the server 5 the number of unprinted labels, which is a difference between the number of printed sheets stored in the label number storage section 132 and the number of printed labels stored in the count storage section 133. Additionally, the unprinted label number transmitter 106 transmits to the server 5 the machine number of the label printer 1 together with the number of unprinted labels.

The print information storing controller 107 stores print information received from the server 5 or the information processing apparatus in the print information storage section 131. The print information includes print data to be printed on the label R, label type, and label size.

The roll sheet selector 501 selects one of roll sheets 4 to be used by the label printer 1 based on the number of printing sheets transmitted from the transmitter 102 and the number of printable labels stored in the label table 542. Specifically, the roll sheet selector 501 selects a roll sheet 4 to be used by the label printer 1 based on the number of printing sheets transmitted by the transmitter 102, the information of label type and label size stored in the print information storage section 131, and the remaining number of labels 5426 on the roll sheet 4 associated with the label type 5423 and label size 5423 stored in the label table 542.

At this time, the roll sheet selector 501 selects a roll sheet 4 that has the remaining number of labels 5426 equal to or more than the number of prints transmitted by the transmitter 102. When the remaining number of labels 5426 of the roll sheet 4 currently attached to the label printer 1 is smaller than the number of prints transmitted by the transmitter 102, the roll sheet selector 501 selects another roll sheet 4 having the same label type and label size transmitted.

The roll sheet selector 501 selects another roll sheet 4 to be used in the label printer 1 from roll sheets 4 which are registered in the label table 142 but are not attached to the label printer 1. Specifically, when the roll sheet selector 501 receives the number of prints from the transmitter 102 and the remaining number of labels of the roll sheet currently attached to the label printer 1, the roll sheet selector 501 may select a roll sheet 4 that is not yet attached to the label printer 1 among the roll sheets 4 stored in the label table 542.

The print instructor 502 instructs another label printer 1 to print the number of unprinted sheets transmitted by the unprinted label number transmitter 106. Specifically, when a plurality of label printers 1 are connected to the label system, the print instructor 502 instructs another label printer 1, which is capable of printing the number of unprinted sheets transmitted by the unprinted label number transmitter 106 to print the number of unprinted sheets. Also, the print instructor 502 transmits the print data to the other label printer 1.

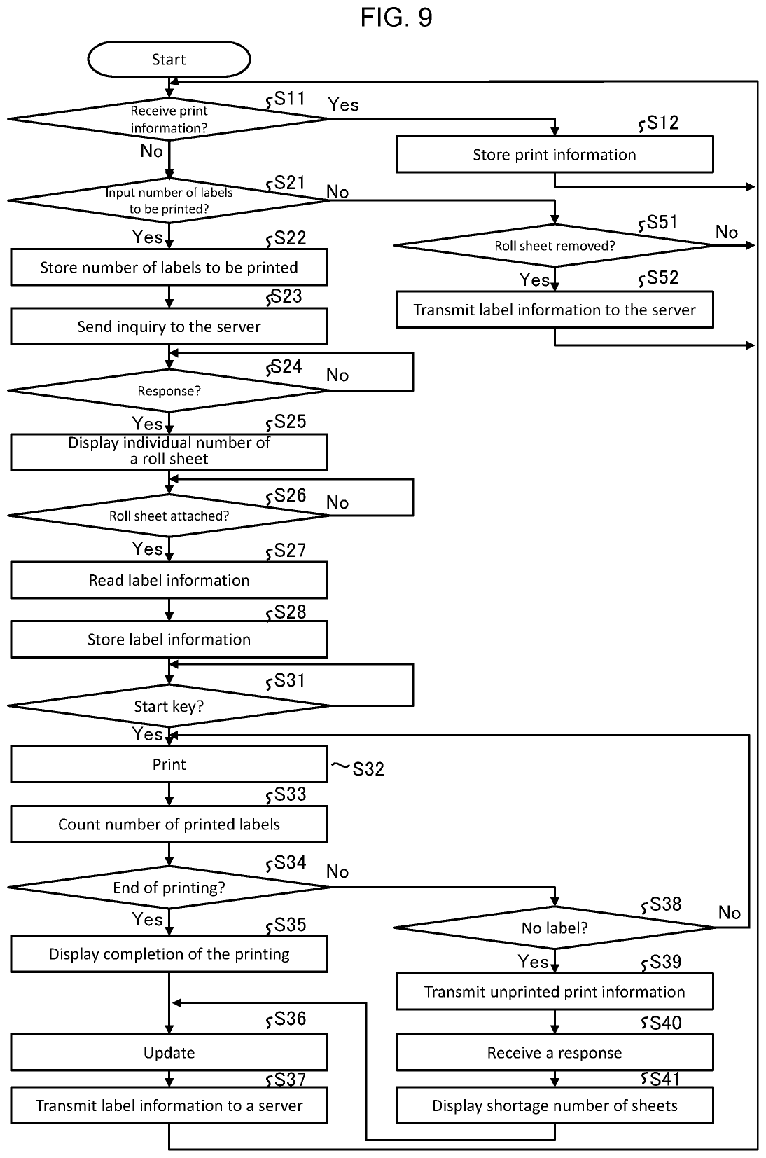

The control of the label printer 1 will now be described. FIG. 9 is a flow chart of the control process of the label printer 1. As shown in FIG. 9, the controller 100 of the label printer 1 determines whether the print information related to the printing of the label R is received from the server 5 or another device (S11). When it is determined that the printing information for printing on the label R is received (Yes in step S11), the print information storing controller 107 stores the print information in the print information storage section 131 (step S12). Then, the controller 100 returns to S11.

When it is determined that the print information to be printed on the label R is not received (No in S11), it is determined whether the number of labels to be printed is input from the operation unit 20 (S21). When it is determined that the number of labels to be printed is input from the operation unit 20 (Yes in S21), the input acceptor 101 stores the number of labels R input from the operation unit 20 in the label number storage section 132 (S22). Next, the transmitter 102 transmits the stored number of labels to be printed and the print information to the server 5 to inquire about the roll sheet 4 to be attached to the label printer (S23). Next, the controller 100 determines whether there is a response to the inquiry in S23 (i.e., information on the roll sheet 4 to be attached to the label printer) from the server 5 (S24). When it is determined that there is the response from the server 5 (Yes in S24), the controller 100 displays the individual number of the roll sheet 4 included in the response on the display 19 (S25).

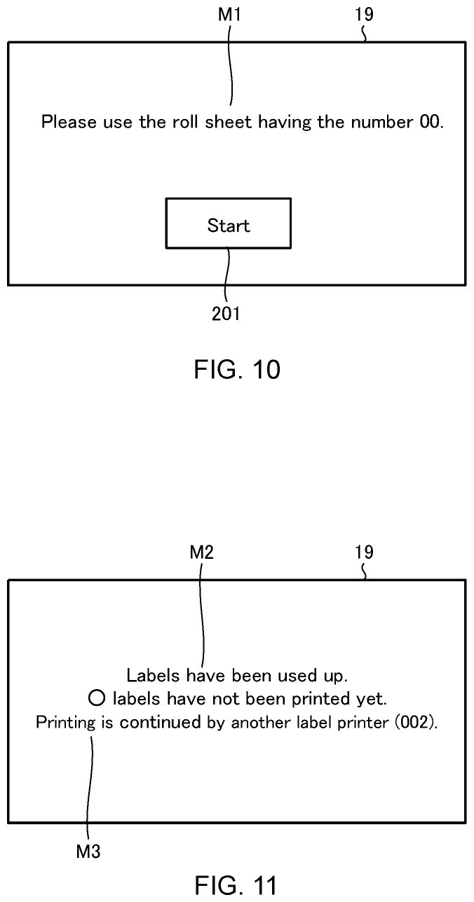

The display of the label printer 1 in S25 will now be described. FIG. 10 is a diagram showing an example of a screen generated by the label printer 1. As shown in FIG. 10, a message M1 indicating an individual number of the roll sheet 4 to be attached is displayed on the display 19. A start key 201 for starting the printing of the label R is displayed on the display 19. The operator of the label printer 1 looks at the display, attaches the roll sheet 4 having the individual number to the label printer 1 displayed thereon, inputs the number of labels to be printed, and operates the start key 201. Then, the label printer 1 starts printing with respect to the label R.

Returning to the description in FIG. 9. Next, the controller 100 determines whether or not the roll sheet 4 that has been indicated by the response from the server 5 is attached to the label printer 1 (S26). When the label mounting sensor 21 detects the attachment of the roll sheet 4, the controller 100 determines that the roll sheet 4 is correctly attached. The controller 100 waits until the appropriate roll sheet is attached (No in S26). When the roll sheet 4 is attached (Yes in S26), the controller 100 reads tag information including label information from the radio tag T attached to the roll sheet 4 by using the radio tag R/W 22. Then, the controller 100 stores the read label information in the label information storage section 142 (S28).

Next, the controller 100 determines whether or not the start key 201 has been operated (S31). The controller 100 waits until the start key 201 is operated (Yes in S31). When the start key 201 is operated, the controller 100 drives the motor 17 to rotate the platen 6, thereby extracting the label R from the attached roll sheet 4. Then, the controller 100 drives the thermal head 8 based on the print data stored in the print information storage section 131, and prints the print data on the label R (S32). Then, the counter 103 counts the number of printed labels, and stores the count value in the count storage section 133 (S33). That is, the count storage section 133 stores the number of labels that have been printed.

Next, the controller 100 determines whether or not printing on the label R is completed (S34). When the printed number of labels stored in the count storage section 133 reaches the number included in the print data stored in the print information storage section 131, the controller 100 determines that printing on the label R has been completed. When the printed number of labels stored in the count storage section 133 has not yet reached the number included in the print data stored in the print information storage section 131, the controller 100 determines that printing on the label R has not been completed. When it is determined that printing on the label R has been completed (Yes in S34), the controller 100 displays a message indicating that printing of the label of the inputted number of prints is completed on the display 19 (S35). The label information updater 104 updates the remaining number of labels 1426 stored in the label information storage section 142 (S36). That is, the label information updater 104 stores the number obtained by subtracting the number of printed labels stored in the count storage section 133 from the remaining number 1426 of labels R as the updated remaining number of labels R (S36). The label information transmitter 105 transmits the updated label information of the roll sheet 4 stored in the label information storage section 142 to the server 5 (S37). Then, the controller 100 returns to S11.

When it is determined in S34 that printing to the label R has not been completed (No in S34), the controller 100 determines whether or not the label R held in the roll sheet 4 attached to the label printer 1 has been used up (i.e., whether all labels R held in the roll sheet 4 have been printed) (S38). A sensor (not shown) for detecting the label R held in the roll sheet 4 is provided in the conveyance path of the label R in the label printer 1. When the sensor detects that there is no label R, the controller 100 determines that label R has been used up.

When it is determined that the label R has been used up (Yes in S38), the unprinted label number transmitter 106 calculates the number of unprinted sheets of the label R that has not yet been printed with respect to the inputted number of sheets to be printed, and transmits the calculated number to the server 5 (S39). Specifically, the unprinted label number transmitter 106 transmits the number obtained by subtracting the number of printed labels stored in the count storage section 133 from the number of labels stored in the label number storage section 132 to the server 5 as the number of unprinted sheets (S39). At this time, the unprinted label number transmitter 106 also transmits the print information to the server 5.

Next, the controller 100 receives a response indicating another label printer 1 that prints the label R of the unprinted number that was transmitted in S39 (S40). Then, the controller 100 displays the received information related to the other label printer 1 on the display 19 (S41).

The information related to the other label printer 1 displayed in step S41 will now be described. FIG. 11 is a diagram showing a screen indicating another label printer 1, generated and displayed by the label printer 1. As shown in FIG. 11, the display 19 displays that the label R is used up. Further, the display 19 displays a message M3 indicating a machine number (“002” in the example of FIG. 11) for specifying another label printer 1 for printing the label R of the number of unprinted sheets. The operator of the label printer 1 can recognize the message M2, grasp the absence of the label and the number of unprinted sheets, and can know another label printer 1 for printing the label R of the number of unprinted sheets.

Then, the controller 100 executes the processing of S36 and the processing of S37. In this case, in the processing in S36, the label information updater 104 updates the remaining number of sheets 1426 to “0”.

When it is determined that the label R has not been used up (No in step S38), the controller 100 returns to step S32 and continues printing of the label R.

In step S21, when it is determined that the number of printed labels is not input (No in step S21), the controller 100 determines whether the roll sheet 4 is removed from the label holding unit 9 based on the output from the label mounting sensor 21 (step S51). When it is determined that the label 142 is removed from the label holding unit 9 (Yes in step S51), the controller 100 retrieves the label information stored in the label information storage section 142 to change the machine number stored in the machine number storage section 1421 to “−”, and transmits it to the server 5 (step S52). Based on the received label information, the server 5 stores information indicating that the roll sheet 4 is removed from the label printer 1, in the machine number field 5421 in the label table 542. When it is determined that the roll sheet 4 is not removed (No in S51), the controller 100 returns to S11.

Although not shown in FIG. 9, when the label printer 1 receives the print instruction by the print instructor 502 together with the unprinted information and the print data from the server 5, the label printer 1 prints the number of labels R included in the unprinted information.

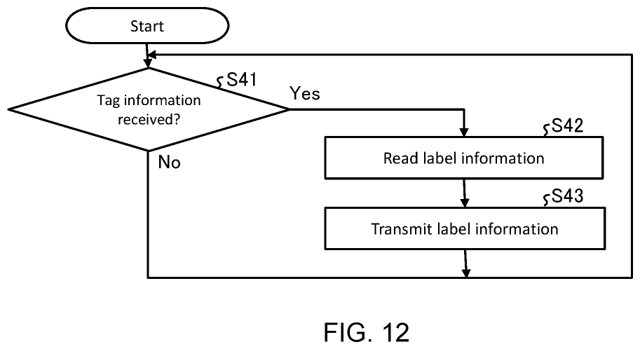

The control of the radio tag reader 3 will now be described. FIG. 12 is a flowchart of control processing performed by the radio tag reader 3. As shown in FIG. 12, the controller 300 of the radio tag reader 3 determines whether or not the antenna 39 has received tag information from the radio tag T attached to the roll sheet 4 (S 41). When the operator of the label printer 1 takes out an unused roll sheet 4 stored in, for example, a corrugated board box, the operator holds the radio tag T over the radio tag reader 3 so that the tag reader 3 can read via the antenna 39 the tag information, which includes label information of the roll sheet 4. When it is determined that the tag information is received from the radio tag T attached to the roll sheet 4 (Yes in S41), the controller 300 reads the tag information received by the antenna 39 (S42). Then, the controller 300 transmits the label information of the roll sheet 4 included in the read tag information to the server 5 (S43). Then, the controller 300 returns to S41. When it is determined that the antenna 39 does not receive the tag information from the radio tag T (No in S41), the controller 300 returns to S41 in.

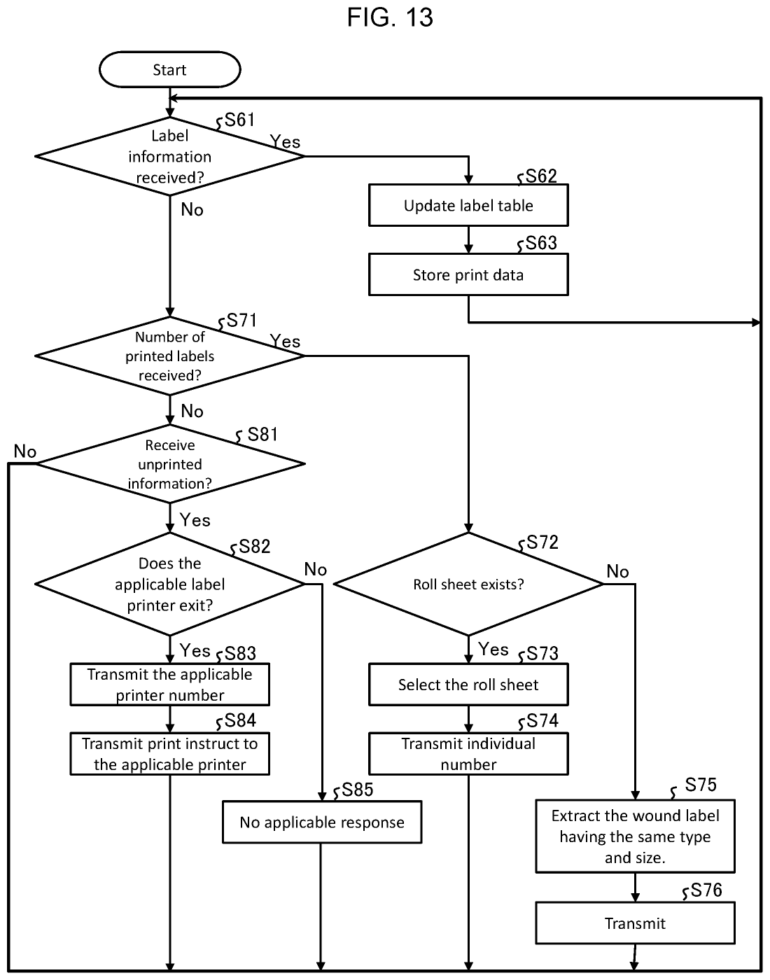

The control of the server 5 will now be described. FIG. 13 is a flow chart of the control process performed by the server 5. As shown in FIG. 13, the controller 500 of the server 5 determines whether or not the label information is received (S61). When it is determined that label information has been received (Yes in S61), the controller 500 updates the information stored in the label table 542 based on the label information (S62). The label information may be received from the radio tag reader 3 and received from the label printer 1. When the label information of the new roll sheet 4 is received from the radio tag reader 3, the controller 500 adds the label information to the label table 542 (S62). When the label information is received from the label printer 1, the label information already stored in the label table 142 is overwritten with the received label information and updated (S62). The received label information corresponds to the label information of label R included in the roll sheet 4 after the label printer 1 has completed printing of label R. Then, the controller 500 stores the received print data in the print data storage section 531 (S63). Then, the controller 500 returns to step S61.

When it is determined that the label information is not received (No in S61), the controller 500 determines whether the number of labels to be printed and the print information are received from the transmitter 102 (S71). When it is determined that the number of labels to be printed and the print information have been received from the transmitter 102 (Yes in step S71), the controller 500 searches the label table 542 and determines whether a roll sheet 4 exists, which is not mounted to the label printer 1 and holds enough numbers of labels R to print the number of labels to be printed transmitted by the transmitter 102 and labels having the same label type and the same label size indicated in the received print information (S72). When it is determined that such a roll sheet 4 exists in the label table 542 (Yes in step S72), the roll sheet selector 501 select the roll sheet 4 to be used for printing the labels (step S73). Then, the controller 500 transmits an individual number identifying the selected roll sheet 4 to the label printer 1 from which the inquiry has been transmitted (S74). Then, the controller 500 returns to step S61.

When it is determined that there is no roll sheet 4 in the label table 542 (No in S72), the controller 500 selects a roll sheet 4 that satisfies the following conditions from the label table 542 (S75). The controller 500 selects a roll sheet, which is not mounted on the label printer 1, which does not have enough number of labels R to print the number of print sheets transmitted by the transmitter 102, and which has the same label type and the same label size included in the received print information (S75). After that, the controller 500 transmits an individual number identifying the selected roll sheet 4 to the label printer 1 from which the inquiry has been transmitted (S76). Then, the controller 500 returns to step S61. In step S75, when it is determined that there is no roll sheet 4 satisfying the above condition, the controller 500 notifies the label printer 1 from which the inquiry has been transmitted.

When the printed sheet number and print information are not received in step S71 (No in step S71), the controller 500 determines whether the unprinted information and the machine number are received (step S81). When it is determined that the unprinted information and the print information are received (Yes in S81), the controller 500 searches the label table 542 based on the number of unprinted labels R included in the unprinted information and the print information (step S82). Then, the controller 500 specifies a roll sheet 4 having the same label type and the same label size as the one of the roll sheet 4 that is mounted on the label printer 1 (step S82). Then, the controller 500 determines whether or not the label printer 1 onto which the roll sheet 4 having the number of labels R more than the number of unprinted sheets is mounted exists (step S82). When it is determined that such a label printer 1 is present (Yes in S82), the controller 500 transmits the machine number specifying the label printer 1 to the label printer 1 from which the inquiry has been transmitted (S83). Then, the print instructor 502 instructs the label printer 1 of the machine number specified in step S83 to print the label of the number of unprinted sheets transmitted by the unprinted label number transmitter 106 (S84). Specifically, the print instructor 502 transmits print data stored in the print data storage section 531, the number of unprinted sheets, and the print command to the label printer 1 of the machine number specified in S83, and issues print instructions for labels R corresponding to the number of unprinted sheets to be printed (S84). Then, the controller 500 returns to step S61.

In step S82, when it is determined that there is no corresponding label printer 1 (No in step S82), the controller 500 transmits a message indicating that there is no corresponding label printer 1 to the label printer 1 from which the inquiry has been transmitted (step S85). Then, the controller 500 returns to step S61.

According to such an embodiment, the roll sheet 4 usable by the roll sheet selector 501 is selected based on the number of labels to be printed received by the input acceptor 101. Therefore, the roll sheet is identified in which the number of labels to be printed can be printed even when the roll sheet 4 is not attached to the label printer 1.

Further, according to the embodiment, the roll sheet selector 501 selects a roll sheet that holds the number of labels that can be printed more than the number of sheets to be printed received by the input acceptor 101. Therefore, the roll sheet 4 is identified in which the number of labels to be printed can be printed even when the roll sheet 4 is not attached to the label printer 1.

In addition, according to the embodiment, when there is no roll sheet for holding the number of labels that can be printed more than the number of sheets to be printed received by the input acceptor 101, the roll sheet is selected based on the label type and the label size included in print information transmitted with the number of the printed sheets. Therefore, it is possible to print the label R by selecting an alternative roll sheet 4.

In addition, according to the embodiment, when the label R is used up before the printing is completed, the number of unprinted sheets of the label R is transmitted to the server 5. The server 5 instructs the other label printer 1 to print the label R corresponding to the number of unprinted sheets. Therefore, when the label R is used up before the printing of the label R is finished, the label R of the number of unprinted sheets can be printed by using the other label printer 1.

For example, in the embodiment, printing of a label is performed based on the number of printed sheets of the label input from the operation unit 20. However, the present invention is not limited thereto, and for example, labels corresponding to the number of printed sheets inputted by receiving from an external apparatus may be printed.

In addition, in the embodiment described above, the label printer 1 and the server 5 are included in the label system. However, the label printer 1 having the function of the server 5 may be used in the label system.

In addition, in the embodiment described above, the label printer 1 and the server 5 are included in the label system. However, the label system may further include another device other than the label printer 1 and the server 5.

Furthermore, according to the embodiment, the roll sheet 4 is described as a roll in which a plurality of unprinted labels is held at regular intervals on an elongated base sheet. However, the present invention is not limited thereto, and for example, the roll sheet 4 may be one in which a plurality of labels having no continuous break in the base paper are held (i.e., linerless labels). In this case, the remaining length of the label is managed in place of the remaining number of labels according to the number of printed sheets of the label.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A label printing system comprising:
a server including
a storage device that stores information about a number of labels remaining on each of a plurality of roll sheets, and
a first controller configured to update the number of labels; and
one or more label printers each including
a display device,
a printing unit configured to print on labels on a roll sheet attached to the label printer,
an input device configured to accept an input of a number of labels to be printed, and
a second controller configured to transmit to the server the input number of labels to be printed,
wherein the first controller is further configured to, upon receipt of the number of labels to be printed from one of the label printers, select one of the roll sheets to be attached to the label printer based on the stored information, and return an identification information about the selected roll sheet, and
the second controller is further configured to, upon receipt of the identification information from the server, generate on the display device a screen indicating the identification information.

2. The system according to claim 1, wherein
the first controller is configured to select one of the roll sheets having a number of remaining labels equal to or greater than the number of labels to be printed.

3. The system according to claim 1, wherein
the storage device stores information about a type and a size of labels remaining on each of the roll sheets,
the second controller is configured to further transmit to the server print data indicating a type and a size of labels to be printed, and
the first controller is configured to select one of the roll sheets based further on the stored information about the type and the size of labels.

4. The system according to claim 3, wherein
the first controller selects one of the roll sheets having remaining labels that are of the type and size indicated by the print data, a number of the remaining labels being equal to or greater than the number of labels to be printed.

5. The system according to claim 4, wherein
when there is no roll sheet having remaining labels that are of the type and size indicated by the print data, a number of the remaining labels being equal to or greater than the number of labels to be printed, the first controller selects one of the roll sheets having remaining labels that are of the type and size indicated by the print data, a number of the remaining labels being less than the number of labels to be printed.

6. The system according to claim 1, wherein
the second controller is configured to, when the label printer has run out of labels on a roll sheet attached to the label printer during printing, transmit to the server a number of lacking labels and print data, and
the first controller is configured to, upon receipt of the number of lacking labels and the print data from the label printer, transmit the print data to another label printer and instruct said another label printer to continue the printing.

7. The system according to claim 6, wherein
the first controller is configured to select one of the roll sheets to be attached to the label printer, which is not attached to any one of the label printers.

8. The system according to claim 1, wherein
the storage device stores information indicating whether each roll sheet is attached to any one of the label printers.

9. The system according to claim 1, wherein
the second controller is further configured to, when the selected roll sheet is attached to the label printer, start printing on labels on the selected roll sheet.

10. The system according to claim 9, wherein
the second controller is further configured to, after the printing is completed, transmit to the server a number of labels remaining on the selected roll sheet.

11. A method for a label printing system including a server and one or more label printers, the method comprising:
storing, in the server, information about a number of labels remaining on each of a plurality of roll sheets;
accepting by one of the label printers an input of a number of labels to be printed;
transmitting from said one of the label printers to the server the input number of labels to be printed;
upon receipt of the number of labels to be printed from said one of the label printers, selecting one of the roll sheets to be attached to the label printer based on the stored information and returning an identification information about the selected roll sheet; and
upon receipt of the identification information from the server, generating on a display of said one of the label printers a screen indicating the identification information.

12. The method according to claim 11, wherein
one of the roll sheets having a number of remaining labels equal to or greater than the number of labels to be printed, is selected.

13. The method according to claim 11, further comprising:
storing, in the server, information about a type and a size of labels remaining on each of the roll sheets; and
transmitting from said one of the label printers to the server print data indicating a type and a size of labels to be printed, wherein
one of the roll sheets is selected based further on the stored information about the type and the size of labels.

14. The method according to claim 13, wherein
one of the roll sheets having remaining labels that are of the type and size indicated by the print data, is selected, wherein a number of the remaining labels is equal to or greater than the number of labels to be printed.

15. The method according to claim 14, wherein
when there is no roll sheet having remaining labels that are of the type and size indicated by the print data, a number of the remaining labels being equal to or greater than the number of labels to be printed,
one of the roll sheets having remaining labels that are of the type and size indicated by the print data, is selected, wherein a number of the remaining labels being less than the number of labels to be printed.

16. The method according to claim 11, further comprising:
when one of the label printers has run out of labels on a roll sheet attached to the label printer during printing, transmitting to the server a number of lacking labels and print data, and
upon receipt of the number of lacking labels and the print data, transmitting the print data to another label printer and instructing said another label printer to continue the printing.

17. The method according to claim 11, further comprising:
storing, in the server, information indicating whether each roll sheet is attached to any one of the label printers.

18. The method according to claim 17, wherein one of the roll sheets not attached to any one of the label printers is selected.

19. The method according to claim 11, further comprising:
when the selected roll sheet is attached to said one of the label printers, starting printing on labels on the selected roll sheet.

20. The method according to claim 19, further comprising:
after the printing is completed, transmitting to the server a number of labels remaining on the selected roll sheet.
